(19) United States
(12) Patent Application Publication
(10) Pub. No.: US 2026/0162135 A1
(43) Pub. Date: Jun. 11, 2026

(54) ARTIFICIAL INTELLIGENCE-BASED ARTIST MARKET PREDICTION SYSTEM USING FANDOM ACTIVITY

(71) Applicant: 5MOTION INC., Seoul (KR)

(72) Inventors: Hyunmee CHOI, Seoul (KR); Jin-Kyum KIM, Seoul (KR); Ye-Won JANG, Uijeongbu-si (KR)

(21) Appl. No.: 18/979,405

(22) Filed: Dec. 12, 2024

(30) Foreign Application Priority Data
Dec. 10, 2024 (KR) 10-2024-0182752

(51) Int. Cl. G06Q 30/0202; G06N 20/00

(52) U.S. Cl. CPC G06Q 30/0202; G06N 20/00

(57) ABSTRACT

An artificial intelligence-based artist market prediction system using a fandom activity includes: a prediction module including a prediction model that predicts a sales volume of an album or performance of a specific artist when fandom activity data of the artist is received; a data collection unit configured to collect the fandom activity data of the artist; a data set generation unit configured to generate a dataset by digitizing the collected fandom activity data, and input the dataset into the prediction model; a result acquisition unit configured to receive result data from the prediction model and output the received result data as the sales volume of the album or performance ticket of the artist; and a learning unit configured to generate a learning dataset using the fandom activity data of the artist and the result data of a next season, and train the prediction model using the generated learning dataset.

### BACKGROUND OF THE INVENTION

### 1. Field of the Invention

The present invention relates to an artificial intelligence-based artist market prediction system using a fandom activity, which collects data about a fandom activity of an artist and predicts a market scale of an album or performance of the artist according to activity data through an artificial intelligence model.

### 2. Description of the Related Art

In general, the scale of the domestic music market has been predicted using indicators indicating an album sales volume and a fandom scale. However, the existing indicators do not fit the current global music market. The lack of reliability of the existing indicators and data distortion problems have been frequently reported. Such problems restrict data-based decision making. In other words, the existing data indicators are low in reliability due to distortion and exaggeration, and there is a limit to the accuracy of decision making based on the existing data indicators.

In particular, recently, music content is consumed by various media platforms such as YouTube and SNS in addition to traditional media platforms such as TV and radio. Therefore, the scale of music content consumption may not be predicted simply by traditional indicators such as an album sales volume.

Further, the scale of a fandom is estimated by the number of fan members, etc. However, even if the number of members is the same, the loyalty or activity level of the members may be different. Rather, the loyalty or activity of the members may have a greater influence on the purchasing power of fandom or the market than the number of members.

That is, the global pop music market is growing rapidly based on the fandom activity. In addition, it is important to analyze and predict the fandom scale and purchasing power by utilizing various data such as an album sales volume, a ticket sales volume, and SNS activities.

Meanwhile, a technology for predicting market trends through social networking service (SNS) data analysis according to changes in the media environment of consumers is being proposed [Patent Document 1]. However, since the related art simply utilizes only social networking service (SNS) data, it is difficult to apply the related art to the music market.

Therefore, a market prediction technology of reflecting the changed media environment and the influence of expanded fandom is required.

### RELATED ART DOCUMENT

### Patent Document

(Patent Document 1) Korean Registered Patent No. 10-2502575 (published on Feb. 21, 2023)

### SUMMARY OF THE INVENTION

To solve the problems as described above, an object of the present invention is to provide an artificial intelligence-based artist market prediction system using a fandom activity, which collects data about a fandom activity of an artist and predicts a market scale of an album or performance of the artist according to activity data through an artificial intelligence model.

To achieve the above object, the present invention relates to an artificial intelligence-based artist market prediction system using a fandom activity, including: a prediction module including a prediction model, in which the prediction model predicts a sales volume of an album or performance ticket of a specific artist when fandom activity data of the artist is received; a data collection unit configured to collect the fandom activity data of the artist; a dataset generation unit configured to generate a dataset by digitizing the collected fandom activity data, and input the dataset into the prediction model; a result acquisition unit configured to receive result data from the prediction model and output the received result data as the sales volume of the album or performance ticket of the artist; and a learning unit configured to generate a learning dataset using the fandom activity data of the artist and the result data of a next season, and train the prediction model using the generated learning dataset.

In addition, in the artificial intelligence-based artist market prediction system using a fandom activity according to the present invention, the fandom activity data may be collected as time series data, the dataset input into the prediction model may be generated as time series data for a preset period of time, and the learning unit may generate a learning dataset by using the fandom activity data and the result data of the next season based on the sales volume of the album or performance ticket for a season immediately after a period of time of the fandom activity data.

In addition, in the artificial intelligence-based artist market prediction system using a fandom activity according to the present invention, the fandom activity data may consist of structured data represented in numerical values and unstructured data represented in text, the system may further includes a digitization unit configured to evaluate the text of the unstructured data as a score, and the digitization unit may evaluate the text of the unstructured data as the score by using a large language model (LLM).

In addition, in the artificial intelligence-based artist market prediction system using a fandom activity according to the present invention, the digitization unit may generate a prompt for inquiring about a positive/negative state of the text and an intensity thereof together with the text of each unstructured data, may transmit the generated prompt to the LLM model to acquire a response, and may determine the positive/negative state of the text and the intensity thereof from the acquired response.

In addition, in the artificial intelligence-based artist market prediction system using a fandom activity according to the present invention, unstructured data corresponding to one feature may consist of a plurality of texts, and the dataset generation unit may average an evaluation score of each of the plurality of texts of the unstructured data, and may set the evaluation score of the unstructured data as an average score.

In addition, in the artificial intelligence-based artist market prediction system using a fandom activity according to the present invention, the dataset generation unit may generate a dataset by adding the structured data and the unstructured data, in which the dataset may be generated as a vector having a size of (n, m) or a plane of n×m, n may represent the number of features, and m may represent the number of time samples.

In addition, in the artificial intelligence-based artist market prediction system using a fandom activity according to the present invention, the structured data may be at least one of the number of YouTube views, the number of YouTube comments, the number of SNS followers, the number of SNS likes, the number of music video views, the number of fan cafe subscribers, a subscriber age distribution, a subscriber region distribution, a subscriber gender distribution, the number of fandom social campaign participants, the number of fan meeting participants, the number of official homepage visitors, and the number of fandom event participants, and, and the unstructured data may be at least one of fandom reviews, SNS posts, fan community posts, performance reviews, SNS hashtags, YouTube comments, fandom news, SNS comments, SNS live streaming comments, and event reviews.

As described above, the system according to the present invention may predict the market scale by using data about the fandom activity, so that data-based decision making may be supported, thereby more accurately predicting the scale of an album or performance.

In addition, the system according to the present invention may integrally analyze quantitative data such as the number of members and the number of views, and qualitative data such as posts, thereby improving prediction accuracy.

### BRIEF DESCRIPTION OF THE DRAWINGS

FIG. 1 is an exemplary diagram of a configuration of an overall system for carrying out the present invention.

FIG. 2 is a block diagram of a configuration of an artificial intelligence-based artist market prediction system using a fandom activity according to one embodiment of the present invention.

FIGS. 3A and 3B are tables showing items of collected data according to one embodiment of the present invention.

### DETAILED DESCRIPTION OF THE INVENTION

Hereinafter, specific details for carrying out the present invention will be described below with reference to the accompanying drawings.

In the description of the present invention, the same elements are denoted by the same reference numerals and will not be repeatedly described.

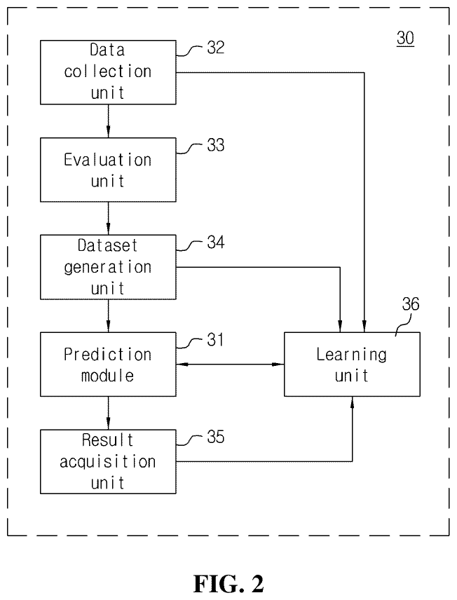

First, examples of a configuration of an overall system for carrying out the present invention will be described with reference to FIG. 2.

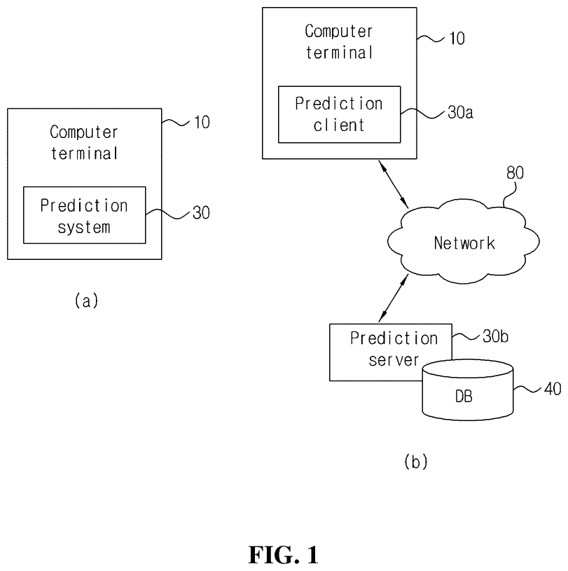

As shown in (a) of FIG. 1, an artificial intelligence-based artist market prediction system using a fandom activity according to the present invention (hereinafter referred to as a prediction system) may be implemented as a program system on a computer terminal 10 that predicts a market scale of an artist.

That is, the prediction system may be implemented as a program system 30 on the computer terminal 10 such as a PC, a smartphone, or a tablet PC. In particular, the prediction system may be configured as the program system, and installed and executed on the computer terminal 10. The prediction system provides a service for predicting the market scale of the artist using hardware or software resources of the computer terminal 10.

In addition, as another embodiment, as shown in (b) of FIG. 1, the prediction system may be configured and executed as a server-client system including a prediction client 30a and a prediction server 30b on the computer terminal 10.

Meanwhile, the prediction client 30a and the prediction server 30b may be implemented according to a typical configuration method of a client and a server. That is, the functions of the overall system may be shared according to performance of the client or an amount of communication with the server. Hereinafter, the prediction system will be described, but the prediction system may be implemented in various forms according to the configuration method of the server-client.

Meanwhile, according to the above embodiments, the computer terminal 10 or the prediction server 30b may include a processor, a memory, etc. In addition, the processor performs a prediction method (or prediction system), and stores collected data, intermediate result data, final result data, etc. in the memory or retrieves the same from the memory. In this case, the processor may include a central processing unit (CPU), a graphic processing unit (GPU), an AI accelerator, a neural processing unit, an AI chip, etc.

Meanwhile, as another embodiment, the prediction system may be implemented by including one electronic circuit such as an application-specific integrated circuit (ASIC), in addition to including a program and operating in a general-purpose computer. Alternatively, the prediction system may be developed as a dedicated computer terminal that exclusively predicts only the market scale of the artist. The prediction system may be implemented in other possible forms.

Next, the artificial intelligence-based artist market prediction system using a fandom activity according to one embodiment of the present invention will be described with reference to FIG. 2.

As shown in FIG. 2, the artificial intelligence-based artist market prediction system includes a prediction module 31 having a prediction model, a data collection unit 32 that collects data, a dataset generation unit 34 that generates a dataset from the collected data, a result acquisition unit 35 that acquires a predicted market scale, and a learning unit 36 that trains the prediction model. Additionally, the artificial intelligence-based artist market prediction system may further include an evaluation unit 33 that digitizes unstructured data.

First, the prediction module 31 includes a prediction model having a neural network circuit.

The prediction model 31 inputs the dataset generated by the dataset generation unit 34 into the prediction model, and transmits data output from the prediction model to the result acquisition unit 35.

The prediction model is an artificial intelligence model that generates a market scale of an album or performance of an artist when fandom activity data is received.

Preferably, the prediction model may be implemented as a conventional neural network circuit such as a convolutional neural network (CNN), a long short-term memory (LSTM), a variational auto-encoder (VAE), an auto-encoder (AE), a graph neural network (GNN), a transformer, or the like.

Meanwhile, internal variables of the neural network circuit of the prediction model are optimized by learning.

In addition, the input data of the prediction model consists of a time series vector of normalized or digitized feature data. In particular, the input data consists of a feature variable and a two-dimensional map (or two-dimensional image) of time. A size of the input data is calculated based on time steps and a feature size. The time steps represent the number of time samples in a time axis unit (e.g., weekly or monthly). The feature size represents the number of features. The input data may be represented as a vector of (n, m) size or a plane (map) of n×m.

Meanwhile, the number of time samples is predetermined. For example, the number of time samples is set to six months, one year, etc.

That is, the input data of the prediction model is data obtained by normalizing or digitizing the fandom activity data of a specific artist.

In addition, the output data of the prediction model is prediction data about a market scale (or sales scale) of the album or performance of the artist. That is, the prediction data is album sales volume (or sales) or performance ticket sales volume (or sales) of the specific artist.

In particular, the output data of the prediction model is market prediction data about one season (or next season).

Next, the data collection unit 32 collects the fandom activity data and season result data of the artist.

The collected fandom activity data consists of structured data represented in numerical values and unstructured data that may not be represented in numerical values.

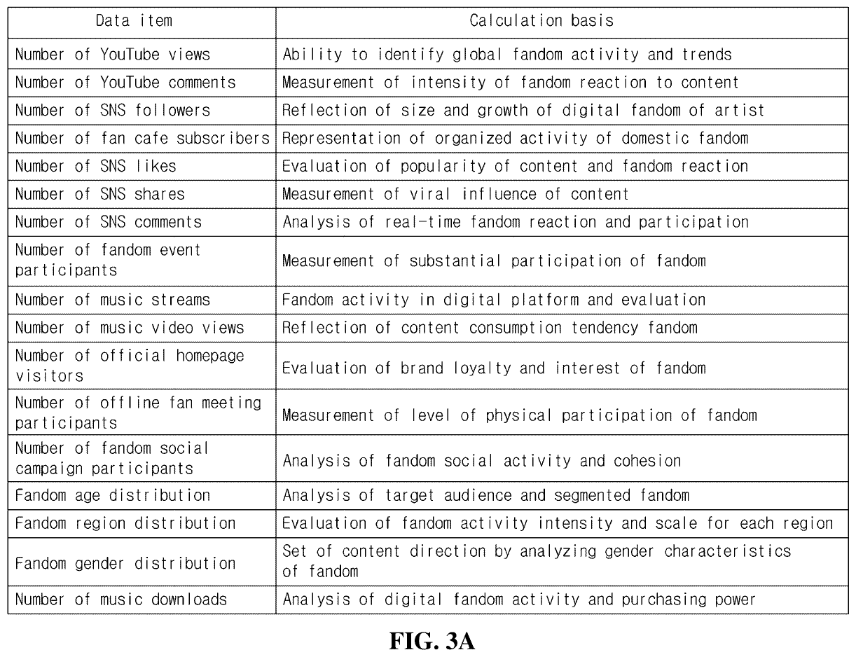

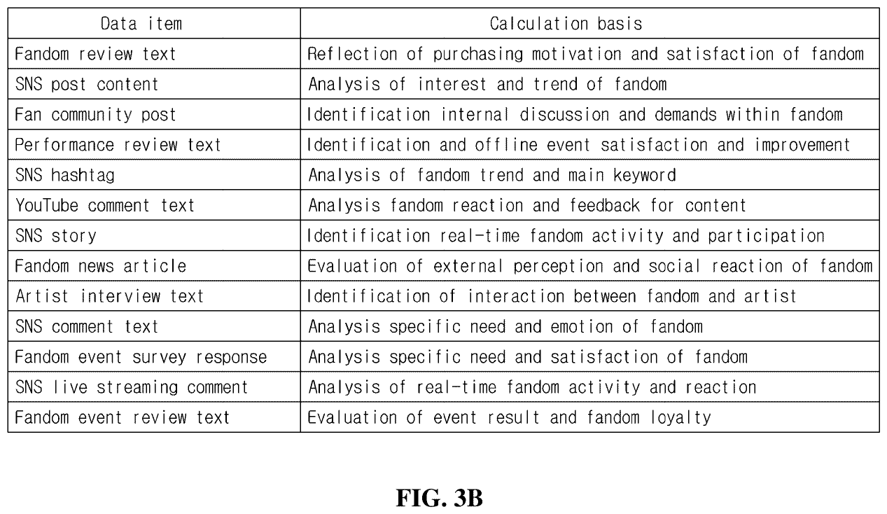

As shown in FIG. 3A, the structured data of a fandom activity includes media platform activity data (the number of YouTube views/comments, the number of SNS followers/likes, the number of music video views, etc.), fandom composition data (the number of fandom subscribers, fandom age/region/gender distribution, etc.), fandom activity data (the number of fandom social campaign participants, the number of fan meeting participants, the number of official homepage visitors, the number of fandom event participants, etc.), and the like. Each item represents one feature of the fandom activity.

In addition, as shown in FIG. 3B, the unstructured data of fandom activity consists of review/post data (media platform/music medium/performance/goods, etc.). In particular, the unstructured data is data that consists of texts or sentences.

In addition, each item represents one feature of the fandom activity. In this case, each item consists of a plurality of unstructured data. For example, a YouTube comment text corresponds to one item (or one feature). In this case, the YouTube comment text consists of a plurality of comments. That is, the unstructured data of one feature consists of a plurality of texts (text sets).

In addition, the data collection unit 32 collects the structured data using an official application programming interface (API) of media platforms such as YouTube and SNS (Instagram, Twitter, etc.). That is, data such as the number of YouTube views, the number of likes, the number of comments, and the number of posts is requested and collected in a JSON format through the API. In addition, even on SNS platforms, the number of followers and post interaction data may be retrieved in real time.

In addition, the data collection unit 32 collects the unstructured data (posts, comments, etc.) of media platforms such as YouTube, official homepage, and SNS (Twitter, Instagram, Facebook, etc.) through a crawling tool (e.g., Scrapy, Selenium). In this case, the data is filtered based on a specific keyword (e.g., artist name, song title, etc.) to store text data of the social media and the community.

Meanwhile, the data collection unit 32 collects the fandom activity data by dividing the fandom activity data into time units. That is, each activity data consists of a series of data according to time units. The time unit is preset to one week, one month, etc. For example, the number of YouTube views consists of consecutive views at intervals of one week. The number of YouTube views is collected based on the number of views investigated in each time unit. In addition, the YouTube comments are collected at intervals of one week from texts written within the corresponding period of time. The YouTube comment at a specific time consists of a plurality of texts (text sets).

That is, both unstructured data and structured data are collected as a series of time series data according to time units (daily, weekly, monthly, etc.). Such a time unit is set according to the purpose of analysis and characteristics of data, and data during the corresponding period of time is aggregated or recorded for each time unit and converted into time series data.

Each series of data represents each feature of the fandom activity.

In addition, the season result data of the artist is result data of an activity in any one season, such as album release or tour performance. A predetermined period of time after an album is released is considered one season. The period of time of a performance tour is considered one season. The season result data consists of album sales volume (or album sales), performance ticket sales volume (or performance sales), and the like.

The season result data is provided by an administrator or the like, or is preset and stored.

Next, the evaluation unit 33 evaluates the unstructured data using a large language model (hereinafter, referred to as an LLM model).

As described above, the unstructured data is data consisting of texts such as posts and comments. The unstructured data of one feature consists of a plurality of texts.

In addition, the large language model (LLM model) is an artificial intelligence model designed to enable natural language processing. The LLM model may identify the context of a question associated with an input prompt and analyze a relationship between words to generate an optimal response (or answer) to the question. The LLM model is pre-trained based on large-scale data. In particular, the LLM model receives the prompt to output a response to the prompt. That is, the LLM model generates a response by predicting a next word or sentence based on learned knowledge for the prompt input by a user. Preferably, the LLM model includes a general large language model such as GPT-4. The LLM model is based on a transformer-type neural network architecture.

The evaluation unit 33 evaluates each text of each unstructured data using the LLM model. That is, as an evaluation result, a positive or negative state and an intensity thereof are extracted. That is, a prompt for inquiring about the positive/negative state of the text and the intensity thereof is generated together with the text of each unstructured data, and the generated prompt is transmitted to the LLM model to acquire a response. In this case, the acquired response includes a positive/negative state of the unstructured data and the intensity thereof.

A prompt template inquiring about the positive/negative state and the intensity thereof may be exemplified as follows.

### [Prompt Template]

“Please let me know if the following text is negative or positive for {artist}. And please evaluate the intensity between 0 and 10 points. [text] {text of unstructured data}”

In this case, the {. . . } symbol at the prompt represents a variable or part to be replaced. In particular, {artist} represents a name or title of a specific artist, and {text of unstructured data} represents text of collected unstructured data.

For example, the positivity or negativity of YouTube comments and the intensity thereof are as follows.
“This album is so good!”=>Positive, Intensity: 8
“This performance wasn't great.”=>Negative, Intensity: 6

The unstructured data corresponding to one feature consists of a plurality of texts (text sets). Each of the plurality of texts (text sets) is evaluated.

Next, the dataset generation unit 34 normalizes or vectorizes the collected activity data to generate a dataset for input of the prediction model. The generated dataset is input into the prediction model.

First, the dataset generation unit 34 normalizes the structured data and converts the structured data into a specific range. The collected data may be excessively dependent on the prediction model because the data scale distribution is not uniform. Therefore, an influence of data collected through the normalization is uniformly adjusted. Accordingly, efficiency of learning for the prediction model 31 may be enhanced.

A normalization method for the structured data uses min-max normalization, Z-score normalization, log transformation, fractional normalization, etc. The min-max normalization converts the data into a range of [0, 1], and Z-score normalization converts the average into 0 and the standard deviation into 1. The logging transformation method adjusts the distribution through log conversion for data having a large-scale difference in data values.

In addition, the dataset generation unit 34 vectorizes a series of the normalized structured data. That is, structured data of one time is converted into one numerical value. A series of structured data collected in time units is converted into one vector. That is, each structured data consists of a single column vector in the form of (n, 1). In this case, n is the number of data samples collected in time units.

For example, the structured data is vectorized as follows. The number of time samples herein is 5.

The number of YouTube Views: [0.2, 0.4, 0.6, 0.8, 1.0]

The number of SNS followers: [0.1, 0.3, 0.5, 0.7, 0.9]

In order to model the time-series structure, data are listed for each time unit. For example, the YouTube views [0.2, 0.4, 0.6, 0.8, 1.0] represent 5 time steps, which means data about 5 consecutive times (t1, t2, t3, t4, and t5).

One vector represents one feature.

In addition, the dataset generation unit 34 converts the digitized unstructured data into a vector.

First, the evaluation result of each text of unstructured data is digitized. That is, the evaluation result of each unstructured data consists of the positivity or negativity, and the intensity thereof. If positive, an intensity score is converted into a positive value, and if negative, an intensity score is converted into a negative value. For example, positive intensity 8 is +8, and negative intensity 6 is −6.

The unstructured data corresponding to one feature consists of a plurality of texts (text sets). In this case, an evaluation score of each text of the text set is averaged, and the evaluation score of the unstructured data is set as an average score. For example, if there are 10 YouTube comments at a specific time, the scores of 10 comments are averaged. In addition, the score of YouTube comments at a specific time is set as an average value.

Further, the score of each unstructured data is normalized.

In addition, the unstructured data corresponding to one feature consists of consecutive data according to time units. The score of a series of structured data according to time units is converted into one vector. That is, each unstructured data consists of a single column vector in the form of (n, 1). In this case, n is the number of data samples collected in time units.

In addition, the dataset generation unit 34 generates a dataset by combining the normalized structured data and the vectorized unstructured data. The dataset is input into the prediction model.

The normalized or digitized structured/unstructured data is referred to as (structured/unstructured) feature data.

A size of the input dataset is calculated based on time steps and a feature size. The time steps represents the number of time samples in a time axis unit (e.g., weekly or monthly). The feature size represents the number of features.

The feature size is represented as the sum of structured data and unstructured data (embedding) features. For example, structured data (10 dimensions)+unstructured data (15 dimensions)=25 dimensions.

The entire data may be represented as a vector of (n, m) size or a plane (map) of n×m. Meanwhile, the number of time samples is predetermined. For example, the number of time steps is set to six months, one year, etc.

Next, the result acquisition unit 35 acquires output data from the prediction module 31 and converts the acquired output data into market prediction data.

That is, the result acquisition unit 35 acquires data that is output by inputting the dataset, which is previously generated by the dataset generation unit 34, into the prediction model 31.

The market prediction data consists of album sales volume (sales) or performance ticket sales volume (sales). In this case, the market prediction data is prediction data about the next season (or one season).

Next, the learning unit 36 adjusts internal variables of the prediction model using a loss function, and uses the loss of a predicted data value and an actual data value.

That is, a loss function is used to update the internal variables (weights of the neural network circuit, etc.) and biases of the prediction model. The loss function is set based on a difference between the prediction data value and the actual data value.

The learning unit 36 trains the prediction model 31 by updating the internal variables of the prediction model 31 using the loss function. The market prediction becomes increasingly sophisticated through the internal variables (weights) of artificial intelligence models (or learned models) updated by the loss function. Accordingly, the prediction value becomes closer to the actual value.

Preferably, the loss function may use a mean squared error (MSE), a weighted MSE, a Huber loss, and the like. The MSE is suitable for feature data of consecutive variables. The weighted MSE is suitable for data having mutually different importance. The Huber loss is suitable for data having a high probability of outliers.

In addition, the learning unit 36 generates a learning dataset from the fandom activity data and the season result data, and trains the prediction model using the learning dataset.

The learning dataset is generated using data collected about a past artist. That is, (the fandom activity data and the season result data) constitute the learning data. In this case, the fandom activity data is used as an input of the neural network circuit, and the season result data is used as an answer data. The fandom activity data corresponding to the number of time samples at a specific period of time is set as input data, and the season result data after the corresponding period of time is set as correct answer data.

Fandom activity data of existing artists (BTS, Black Pink, etc.) are used for time series learning. The learned prediction model may be used to predict a market scale of the next season of a new artist. That is, after learning the correlation between the fandom activity amount and the album/ticket sales volume through the existing artist data, the album/performance sales volume of the next season may be predicted by inputting initial fandom activity data of the new artist.

Although the present invention invented by the present inventor has been described in detail with reference to the embodiments, the present invention is not limited to the above embodiments, and various modifications are possible without departing from the scope and spirit of the present invention.

What is claimed is:

1. An artificial intelligence-based artist market prediction system using a fandom activity, the artificial intelligence-based artist market prediction system comprising:
a prediction module including a prediction model, in which the prediction model predicts a sales volume of an album or performance ticket of a specific artist when fandom activity data of the artist is received;
a data collection unit configured to collect the fandom activity data of the artist;
a dataset generation unit configured to generate a dataset by digitizing the collected fandom activity data, and input the dataset into the prediction model;
a result acquisition unit configured to receive result data from the prediction model and output the received result data as the sales volume of the album or performance ticket of the artist; and
a learning unit configured to generate a learning dataset using the fandom activity data of the artist and the result data of a next season, and train the prediction model using the generated learning dataset.

2. The artificial intelligence-based artist market prediction system of claim 1, wherein the fandom activity data is collected as time series data,
the dataset input into the prediction model is generated as time series data for a preset period of time, and
the learning unit generates a learning dataset by using the fandom activity data and the result data of the next season based on the sales volume of the album or performance ticket for a season immediately after a period of time of the fandom activity data.

3. The artificial intelligence-based artist market prediction system of claim 1, wherein the fandom activity data consists of structured data represented in numerical values and unstructured data represented in text,
the system further comprises a digitization unit configured to evaluate the text of the unstructured data as a score, and
the digitization unit evaluates the text of the unstructured data as the score by using a large language model (LLM).

4. The artificial intelligence-based artist market prediction system of claim 3, wherein the digitization unit generates a prompt for inquiring about a positive/negative state of the text and an intensity thereof together with the text of each unstructured data, transmits the generated prompt to the LLM model to acquire a response, and determines the positive/negative state of the text and the intensity thereof from the acquired response.

5. The artificial intelligence-based artist market prediction system of claim 3, wherein unstructured data corresponding to one feature consists of a plurality of texts, and
the dataset generation unit averages an evaluation score of each of the plurality of texts of the unstructured data, and sets the evaluation score of the unstructured data as an average score.

6. The artificial intelligence-based artist market prediction system of claim 5, wherein the dataset generation unit generates a dataset by adding the structured data and the unstructured data, in which the dataset is generated as a vector having a size of (n, m) or a plane of n×m, n represents the number of features, and m represents the number of time samples.

7. The artificial intelligence-based artist market prediction system of claim 3, wherein the structured data is at least one of the number of YouTube views, the number of YouTube comments, the number of SNS followers, the number of SNS likes, the number of music video views, the number of fan cafe subscribers, a subscriber age distribution, a subscriber region distribution, a subscriber gender distribution, the number of fandom social campaign participants, the number of fan meeting participants, the number of official homepage visitors, and the number of fandom event participants, and
the unstructured data is at least one of fandom reviews, SNS posts, fan community posts, performance reviews, SNS hashtags, YouTube comments, fandom news, SNS comments, SNS live streaming comments, and event reviews.
